(19) United States
(12) Patent Application Publication
(10) Pub. No.: US 2016/0046192 A1
(43) Pub. Date: Feb. 18, 2016

(54) MOVEMENT MECHANISM

(71) Applicant: IHI CORPORATION, Tokyo (JP)

(72) Inventors: Yuji TAKATSU, Tokyo (JP); Akio UEDA, Tokyo (JP); Motonao NIIZUMA, Tokyo (JP); Kei AKUNE, Tokyo (JP); Tooru HAYASHI, Tokyo (JP); Akihiko TSUCHIYAMA, Tokyo (JP); Kazushi SEDOKUBO, Tokyo (JP); Masaki KAWAKITA, Tokyo (JP); Mai KANDA, Tokyo (JP); Gongwei LI, Tokyo (JP); Ryota KOKUBU, Tokyo (JP)

(73) Assignee: IHI CORPORATION, Tokyo (JP)

(21) Appl. No.: 14/927,745

(22) Filed: Oct. 30, 2015

Related U.S. Application Data
(63) Continuation of application No. PCT/JP2014/067115, filed on Jun. 27, 2014.

(30) Foreign Application Priority Data
Jul. 18, 2013 (JP) 2013-149844

(51) Int. Cl. B60L 5/00; B60L 9/00

(52) U.S. Cl. CPC B60L 5/005; B60L 9/00

(57) ABSTRACT

A movement mechanism includes a plurality of primary power-supplying coils each serving as a power-supplying coil that is able to supply power to another power-supplying coil in a wireless manner and arranged along an imaginary line parallel to the movement path, a secondary power-supplying coil serving as a power-supplying coil configured to receive power from another power-supplying coil in a wireless manner; and a movement structure serving as a structure configured to support the secondary power-supplying coil and to move along the movement path, wherein power is able to be supplied in a wireless manner to the secondary power-supplying coil from one or more of the primary power-supplying coils sequentially selected from among the plurality of primary power-supplying coils depending on an arrangement sequence when the movement structure moves along the movement path.

This application is a continuation application based on a PCT Patent Application No. PCT/JP2014/067115, filed on Jun. 27, 2014, whose priority is claimed on Japanese Patent Application No. 2013-149844, filed on Jul. 18, 2013. The contents of both the PCT application and the Japanese Patent Application are incorporated herein by reference.

### TECHNICAL FIELD

The present disclosure relates to a movement mechanism that can move along a movement path.

### BACKGROUND ART

In industries, various movement mechanisms are used, and in general, trolley power supplying for supplying power from a stationary side to a movement structure is performed.

In recent years, wireless power-supplying systems have been proposed. Here, the inventor(s) has come up with a movement mechanism configured to supply power from a stationary side to a movement structure in a wireless manner.

For example, a primary power-supplying coil is installed at the stationary side, and a secondary power-supplying coil is installed at the movement structure.

According to the wireless method, it is required to supply power with small energy loss from the primary power-supplying coil to the secondary power-supplying coil.

FIGS. 8A and 8B show a concept of a wireless power-supplying system.

FIGS. 8A and 8B are disclosed in U.S. Pat. No. 8,035,255.

In addition, when power is supplied from the primary power-supplying coil to the secondary power-supplying coil in a wireless manner, the way to use the method should be easy.

### DOCUMENT OF RELATED ART

### Patent Document

### [Patent Document 1] Japanese Unexamined Patent Application, First Publication No. 2011-97814

[Patent Document 2] U.S. Pat. No. 8,035,255
[Patent Document 3] U.S. Pat. No. 8,106,539

### [Patent Document 4] Japanese Unexamined Patent Application, First Publication No. 2012-239331

### [Patent Document 5] Japanese Unexamined Patent Application, First Publication No. 2008-120239

### [Patent Document 6] Japanese Unexamined Patent Application, First Publication No. 2011-211874

### SUMMARY

### Technical Problem

While it is assumed in the technology of the above-mentioned Patent Document that power is supplied to a movement structure that is stopped, in order to facilitate a use method of wireless power supplying, it should be possible to supply power to a movement structure that is moving. Accordingly, since the present disclosure is proposed in consideration of the above-mentioned problems, a movement mechanism capable of realizing power supplying to a movement structure that is moving is provided.

### Solution to Problem

A movement mechanism of the present disclosure is a movement mechanism that is able to move along a movement path, the movement mechanism including a plurality of primary power-supplying coils each serving as a power-supplying coil that is able to supply power to another power-supplying coil in a wireless manner and arranged along an imaginary line parallel to the movement path; a secondary power-supplying coil serving as a power-supplying coil configured to receive power from another power-supplying coil in a wireless manner; and a movement structure serving as a structure configured to support the secondary power-supplying coil and to move along the movement path, wherein power is able to be supplied in a wireless manner to the secondary power-supplying coil from one or more of the primary power-supplying coils sequentially selected from among the plurality of primary power-supplying coils depending on an arrangement sequence when the movement structure moves along the movement path.

Hereinafter, the movement mechanism according to the embodiment of the present disclosure will be described. The present disclosure includes any one of the embodiments described below or aspects, or a combination constituted by two or more of these.

The wireless power-supplying system according to the embodiment of the present disclosure can maintain a state, in which power is supplied in a wireless manner to the secondary power-supplying coil from one or more of the primary power-supplying coils sequentially selected from among the plurality of primary power-supplying coils depending on an arrangement sequence, is able to be maintained when the movement structure moves along the movement path.

The movement mechanism according to the embodiment of the present disclosure can maintain a state, in which power is supplied in a wireless manner to the secondary power-supplying coil from one or more of the primary power-supplying coils among the plurality of primary power-supplying coils, is able to be maintained when the movement structure is stopped at an arbitrary position on the movement path.

The movement mechanism according to the embodiment of the present disclosure includes the plurality of secondary power-supplying coils, wherein the movement structure supports the plurality of secondary power-supplying coils so that the plurality of secondary power-supplying coils are arranged along the imaginary line parallel to the movement path, and power is able to be supplied in a wireless manner to one or more of the secondary power-supplying coils sequentially selected from among the plurality of secondary power-supplying coils depending on an arrangement sequence from one or more of the primary power-supplying coils sequentially selected from among the plurality of primary power-supplying coils depending on an arrangement sequence so that a state, in which power is supplied in a wireless manner from the primary power-supplying coil to the secondary power-supplying coil, is maintained when the movement structure moves along the movement path.

The movement mechanism according to the embodiment of the present disclosure includes the plurality of secondary power-supplying coils, wherein the movement structure supports the plurality of secondary power-supplying coils so that the plurality of secondary power-supplying coils are arranged along the imaginary line parallel to the movement path, and power is able to be supplied in a wireless manner to one or more of the secondary power-supplying coils selected from the plurality of secondary power-supplying coils from one or more of the primary power-supplying coils among the plurality of primary power-supplying coils in a wireless manner so that a state, in which power is supplied in a wireless manner from the primary power-supplying coil to the secondary power-supplying coil, is maintained when the movement structure is stopped at an arbitrary position on the movement path.

In the movement mechanism according to the embodiment of the present disclosure, the movement structure has a movement structure main body and a coil positioning mechanism supported by the movement structure main body and configured to vary the posture of the secondary power-supplying coil, and the coil positioning mechanism varies the posture of the secondary power-supplying coil so that a state, in which power is supplied in a wireless manner to the secondary power-supplying coil from one or more of the primary power-supplying coils among the plurality of primary power-supplying coils, is able to be maintained when the movement structure is stopped at an arbitrary position on the movement path.

In the movement mechanism according to the embodiment of the present disclosure, the movement structure has a movement structure main body and a coil movement mechanism configured to move the secondary power-supplying coil along the imaginary line, and the coil movement mechanism moves the secondary power-supplying coil along the imaginary line so that a state, in which power is supplied in a wireless manner to the secondary power-supplying coil from one or more of the primary power-supplying coils among the plurality of primary power-supplying coils, is able to be maintained when the movement structure is stopped at an arbitrary position on the movement path.

In the movement mechanism according to the embodiment of the present disclosure, the movement path has an X-axis movement path and a Y-axis movement path that are movement paths crossing each other, and the movement structure moves along either movement path selected from the X-axis movement path or the Y-axis movement path.

### Effects of Disclosure

As described above, the movement mechanism according to the present disclosure has the following effects depending on the above-mentioned configurations.

When the movement structure is moved along the movement path, since the power can be supplied in a wireless manner to the secondary power-supplying coil supported by the movement structure from one or more of the primary power-supplying coils sequentially selected from among the plurality of primary power-supplying coils arranged along the imaginary line parallel to the movement path depending on an arrangement sequence, the power can be supplied to the movement structure that is moving.

In addition, when the movement structure is moved along the movement path, since a state, in which power is supplied in a wireless manner to the secondary power-supplying coil supported by the movement structure from one or more of the primary power-supplying coils sequentially selected from among the plurality of primary power-supplying coils arranged along the imaginary line parallel to the movement path depending on an arrangement sequence, can be maintained, the power can be continuously supplied to the movement structure that is moving.

In addition, when the movement structure is stopped at an arbitrary position on the movement path, since the state, in which power is supplied in a wireless manner to the secondary power-supplying coil supported by the movement structure from one or more of the primary power-supplying coils of the plurality of primary power-supplying coils arranged along the imaginary line parallel to the movement path, can be maintained, the power can be continuously supplied to the movement structure that is stopped.

In addition, when the movement structure is moved along the movement path, since the state, in which power is supplied in a wireless manner to one or more of the secondary power-supplying coils sequentially selected from among the plurality of secondary power-supplying coils supported by the movement structure depending on an arrangement sequence from one or more of the primary power-supplying coils sequentially selected from among the plurality of primary power-supplying coils arranged along the imaginary line parallel to the movement path depending on an arrangement sequence, can be maintained, the power can be continuously supplied to the movement structure that is moving.

In addition, when the movement structure is stopped at an arbitrary position on the movement path, since the state, in which power is supplied in a wireless manner to one or more of the secondary power-supplying coils sequentially selected from among the plurality of secondary power-supplying coils supported by the movement structure depending on an arrangement sequence from one or more of the primary power-supplying coils sequentially selected from among the plurality of primary power-supplying coils arranged along the imaginary line parallel to the movement path depending on an arrangement sequence, can be maintained, the power can be continuously supplied to the movement structure that is moving.

In addition, when the movement structure is stopped at an arbitrary position on the movement path, since the coil positioning mechanism varies the posture of the secondary power-supplying coil and the state, in which power is supplied in a wireless manner to the secondary power-supplying coil from one or more of the primary power-supplying coils of the plurality of primary power-supplying coils, can be maintained, the power can be continuously supplied to the movement structure that is stopped.

In addition, when the movement structure is stopped at an arbitrary position on the movement path, since the coil movement mechanism moves the secondary power-supplying coil along the imaginary line and the state, in which power is supplied in a wireless manner to the secondary power-supplying coil from one or more of the primary power-supplying coils of the plurality of primary power-supplying coils, can be maintained, the power can be continuously supplied to the movement structure that is stopped.

In addition, since the movement structure is moved along any one movement path selected from the X-axis movement path and the Y-axis movement path crossing the movement structure, the power can be supplied to the movement structure moving along the X-axis movement path and the Y-axis movement path crossing each other.

Accordingly, it is possible to provide the movement mechanism capable of reducing energy loss due to a simple structure and facilitating use of wireless power supplying.

### BRIEF DESCRIPTION OF DRAWINGS

FIG. 1 is a conceptual view of a movement mechanism according to a first embodiment of the present disclosure.

FIG. 2 is a conceptual view of a movement mechanism according to a second embodiment of the present disclosure.

FIG. 3 is a conceptual view of a movement mechanism according to a third embodiment of the present disclosure.

FIG. 4 is a conceptual view of a movement mechanism according to a fourth embodiment of the present disclosure.

FIG. 5 is a conceptual view of a movement mechanism according to a fifth embodiment of the present disclosure.

FIG. 6 is a conceptual view of a movement mechanism according to a sixth embodiment of the present disclosure.

FIG. 7 is a conceptual view of a movement mechanism according to a seventh embodiment of the present disclosure.

FIG. 8A is a conceptual view of a wireless power-supplying system.

FIG. 8B is a conceptual view of a wireless power-supplying system.

### DESCRIPTION OF EMBODIMENTS

Hereinafter, embodiments of the present disclosure will be described with reference to the accompanying drawings.

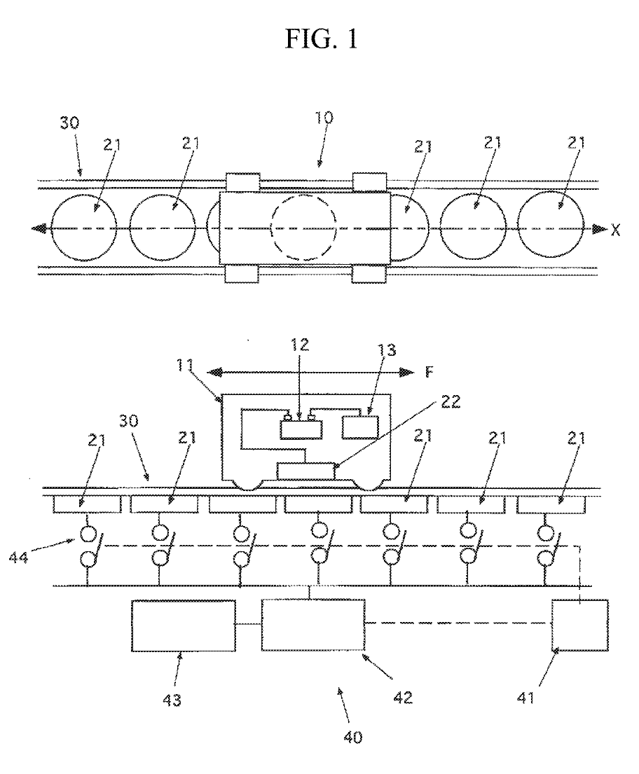

Initially, a wireless power-supplying system according to a first embodiment of the present disclosure will be described with reference to FIG. 1.

FIG. 1 is a conceptual view of a movement mechanism according to the first embodiment of the present disclosure.

A movement mechanism is a mechanism that is movable along a movement path F.

The movement path F may be a linear path.

The movement path F may be a curved path.

The movement path F may be a path formed by combining a linear shape and a curved shape.

The movement path F may be a path disposed on a horizontal plane.

The movement path F may be a path disposed on a surface including an inclined surface.

The movement path F may be a path disposed three-dimensionally.

The movement path F may be a path disposed on a wall.

The movement path F may be a path disposed on a floor.

The movement path F may be a path disposed on a ceiling.

The movement mechanism is constituted by a plurality of primary power-supplying coils 21, a secondary power-supplying coil 22 and a movement structure 10.

The movement mechanism may be constituted by the plurality of primary power-supplying coils 21, the secondary power-supplying coil 22, the movement structure 10 and a movement guide mechanism 30, or may be constituted by the plurality of primary power-supplying coils 21, the secondary power-supplying coil 22, the movement structure 10, the movement guide mechanism 30 and a power-supplying device 40.

The plurality of primary power-supplying coils 21 each serving as a power-supplying coil that can supply power (electric power) to another power-supplying coil in a wireless manner are arranged along an imaginary line X parallel to the movement path F.

For example, the plurality of primary power-supplying coils 21 each serving as a power-supplying coil that can supply power to the secondary power-supplying coil 22 in a wireless manner are arranged along the imaginary line X parallel to the movement path F.

The plurality of primary power-supplying coils 21 each serving as a power-supplying coil that can supply power to another power-supplying coil in a wireless manner may be arranged in series along the imaginary line X parallel to the movement path F.

The plurality of primary power-supplying coils 21 each serving as a power-supplying coil that can supply power to another power-supplying coil in a wireless manner may be arranged in a zigzag along the imaginary line X parallel to the movement path F.

The secondary power-supplying coil 22 is a power-supplying coil that receives power from another power-supplying coil in a wireless manner.

For example, the secondary power-supplying coil 22 is a power-supplying coil that receives power from the primary power-supplying coil 21 in a wireless manner.

For example, the secondary power-supplying coil 22 is a power-supplying coil that receives power from the primary power-supplying coil 21 disposed therebelow.

When current flows to the primary power-supplying coil 21, a magnetic field is generated in a space, and induced current is generated by the magnetic field at the secondary power-supplying coil 22 in the magnetic field.

For example, when alternating current flows to the primary power-supplying coil 21, a magnetic field is generated in a space, and induced current is generated by the magnetic field at the secondary power-supplying coil 22 in the magnetic field.

As a result, the secondary power-supplying coil 22 receives power from the primary power-supplying coil 21 in a wireless manner.

For example, the secondary power-supplying coil 22 receives power from the primary power-supplying coil 21 in any one of a magnetic field resonance type, an electric field resonance type and an electromagnetic induction type in a wireless manner.

The movement structure 10 is a structure configured to support the secondary power-supplying coil 22 and move along the movement path F.

The movement structure 10 is constituted by the movement structure main body 11, a storage cell 12 and an electric load 13.

The movement structure main body 11 is a main body of the movement structure 10, and moves along the movement path.

When the movement guide mechanism 30 (to be described below) is a traveling rail 31, the movement structure main body 11 holds wheels that roll on the traveling rail 31.

For example, the secondary power-supplying coil 22 is installed at a lower section of the movement structure main body 11.

The storage cell 12 is an instrument configured to store power.

The storage cell 12 stores power supplied to the secondary power-supplying coil 22.

For example, the storage cell 12 is a battery, a capacitor, a flywheel, or the like.

The electric load 13 is an instrument configured to execute a function by consuming power discharged from the storage cell 12.

For example, the electric load 13 is an electric motor configured to rotate the wheels.

The movement guide mechanism 30 is a mechanism configured to movably guide the movement structure 10 along the movement path F.

For example, the movement guide mechanism 30 is the traveling rail 31.

The traveling rail 31 extends along the movement path F.

The power-supplying device 40 is a device configured to supply power from the plurality of primary power-supplying coils 21 to the secondary power-supplying coil 22 in a wireless manner.

The power-supplying device 40 is constituted by a control instrument 41, a driving instrument 42, a power supply instrument 43 and a plurality of switches 44.

The control instrument 41 is an instrument configured to control the power-supplying device 40.

The control instrument 41 controls the driving instrument 42 and the plurality of switches 44.

The control instrument 41 controls the driving instrument 42.

The control instrument 41 turns the plurality of switches 44 on and off.

When the control instrument 41 turns the switch 44 on, the switch 44 that is turned on electrically connects the primary power-supplying coil 21 and the driving instrument 42.

The driving instrument 42 drives the primary power-supplying coil 21.

The driving instrument 42 has a matching circuit and a switching circuit.

The matching circuit adjusts an electrical property of an electromagnetic circuit constituted by the primary power-supplying coil 21 and the secondary power-supplying coil 22, and increases efficiency of wireless power supplying from the primary power-supplying coil 21 to the secondary power-supplying coil 22.

The switching circuit switches electricity from the power supply instrument 43 to supply power having desired current, voltage and frequency to the primary power-supplying coil 21 via the matching circuit.

When the movement structure 10 moves along the movement path F, power can be supplied to the secondary power-supplying coil 22 from one or more of the primary power-supplying coils 21 selected from among the plurality of primary power-supplying coils 21 depending on an arrangement sequence in a wireless manner.

When the movement structure 10 moves along the movement path F, power can be supplied to the secondary power-supplying coil 22 from one or more of the primary power-supplying coils 21 sequentially selected from among the plurality of primary power-supplying coils 21 depending on an arrangement sequence in a wireless manner.

When the movement structure 10 moves along the movement path F, power may be supplied to the secondary power-supplying coil 22 from one or more of the primary power-supplying coils 21 sequentially selected to correspond to movement from among the plurality of primary power-supplying coils 21 depending on an arrangement sequence in a wireless manner.

When the movement structure 10 is guided by the movement guide mechanism 30 to move along the movement path, power may be supplied to the secondary power-supplying coil 22 from one or more of the primary power-supplying coils 21 sequentially selected to correspond to movement from among the plurality of primary power-supplying coils 21 depending on an arrangement sequence in a wireless manner.

When the movement structure 10 moves along the movement path F, the control instrument 41 turns the switch 44 on or off, and power can be supplied to the secondary power-supplying coil 22 from one or more of the primary power-supplying coils 21 sequentially selected from among the plurality of primary power-supplying coils 21 depending on an arrangement sequence in a wireless manner.

For example, when the movement structure 10 moves along the movement path F, the control instrument 41 selects the primary power-supplying coil 21 having relatively better efficiency of supplying power to the secondary power-supplying coil 22 in a wireless manner from the plurality of primary power-supplying coils 21, turns on the switch 44 disposed at an electrical circuit that supplies power to the selected primary power-supplying coil, turns another switch 44 off, controls the driving instrument 42, and supplies power to the secondary power-supplying coil from the selected primary power-supplying coil 21 in a wireless manner.

In this way, the power can be supplied to the secondary power-supplying coil 22 from one or more of the primary power-supplying coils 21 sequentially selected from among the plurality of primary power-supplying coils 21 to correspond to movement depending on an arrangement sequence in a wireless manner.

When the movement structure 10 moves along the movement path F, a state, in which power is supplied in a wireless manner to the secondary power-supplying coil 22 from one or more of the primary power-supplying coils 21 sequentially selected from among the plurality of primary power-supplying coils 21 depending on an arrangement sequence, may be maintained.

When the movement structure 10 is guided by the movement guide mechanism 30 to move along the movement path F, the state, in which power is supplied in a wireless manner to the secondary power-supplying coil 22 from one or more of the primary power-supplying coils 21 sequentially selected from among the plurality of primary power-supplying coils 21 depending on an arrangement sequence, may be maintained.

When the movement structure 10 is guided by the movement guide mechanism 30 to move along the movement path F, a state, in which power is supplied in a wireless manner to the secondary power-supplying coil from one or more of the primary power-supplying coils sequentially selected from among the plurality of primary power-supplying coils to correspond to movement depending on an arrangement sequence, may be maintained.

When the movement structure 10 moves along the movement path F, the control instrument 41 may sequentially select one or more of the primary power-supplying coils 21 from among the plurality of primary power-supplying coils 21 depending on an arrangement sequence, and maintain the state, in which power is supplied in a wireless manner to the secondary power-supplying coil 22 from the selected one or more primary power-supplying coils 21.

When the movement structure 10 moves along the movement path F, the control instrument 41 may select the primary power-supplying coil 21 having relatively better efficiency of supplying power to the secondary power-supplying coil 22 in a wireless manner from the plurality of primary power-supplying coils 21, and maintain the state, in which power is supplied in a wireless manner to the secondary power-supplying coil 22 from the selected one or more primary power-supplying coils 21.

In this way, the power can be supplied to the secondary power-supplying coil 22 from one or more of the primary power-supplying coils 21 sequentially selected from among the plurality of primary power-supplying coils 21 to correspond to movement depending an arrangement sequence in a wireless manner.

When the movement structure 10 is stopped at an arbitrary position on the movement path F, the state, in which power is supplied in a wireless manner to the secondary power-supplying coil 22 from one or more of the primary power-supplying coils 21 of the plurality of primary power-supplying coils 21, may be maintained.

When the movement structure 10 is guided by the movement guide mechanism 30 to stop at an arbitrary position on the movement path F, the state, in which power is supplied in a wireless manner to the secondary power-supplying coil 22 from one or more of the primary power-supplying coils 21 of the plurality of primary power-supplying coils 21, may be maintained.

When the movement structure 10 is stopped at an arbitrary position on the movement path F, the control instrument 41 may select the primary power-supplying coil 21 having relatively better efficiency of supplying power to the secondary power-supplying coil 22 in a wireless manner from the plurality of primary power-supplying coils 21, and maintain the state, in which power is supplied in a wireless manner to the secondary power-supplying coil 22 from the selected one or more primary power-supplying coils 21.

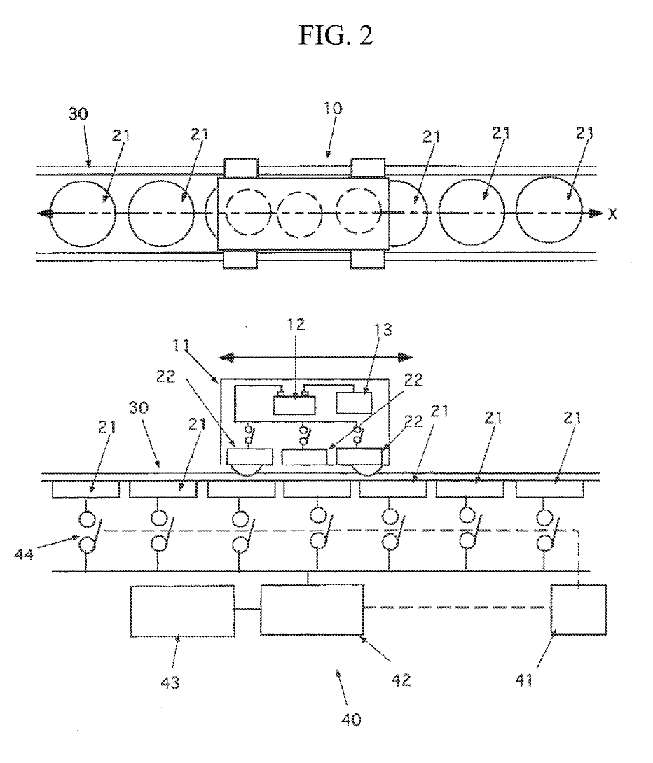

Next, a movement mechanism according to a second embodiment of the present disclosure will be described with reference to FIG. 2.

FIG. 2 is a conceptual view of the movement mechanism according to the second embodiment of the present disclosure.

The movement mechanism is a mechanism that can move along the movement path F.

The movement mechanism is constituted by a plurality of primary power-supplying coils 21, a plurality of secondary power-supplying coils 22 and a movement structure 10.

The movement mechanism may be constituted by the plurality of primary power-supplying coils 21, the plurality of secondary power-supplying coils 22, the movement structure 10 and a movement guide mechanism 30, or may be constituted by the plurality of primary power-supplying coils 21, the plurality of secondary power-supplying coils 22, the movement structure 10, the movement guide mechanism 30 and a power-supplying device 40.

Since a structure of the plurality of primary power-supplying coils is the same as the movement mechanism according to the first embodiment, a description thereof will be omitted.

The plurality of secondary power-supplying coils 22 each serving as a power-supplying coil configured to receive power from another power-supplying coil in a wireless manner are arranged along the imaginary line X parallel to the movement path F when the movement structure 10 moves along the movement path.

The plurality of secondary power-supplying coils 22 each serving as a power-supplying coil configured to receive power from the primary power-supplying coil 21 in a wireless manner may be arranged along the imaginary line X parallel to the movement path F when the movement structure 10 moves along the movement path.

The plurality of secondary power-supplying coils 22 each serving as a power-supplying coil configured to receive power from another power-supplying coil in a wireless manner may be arranged in series along the imaginary line X parallel to the movement path F when the movement structure 10 moves along the movement path.

Since an aspect of supplying power from the primary power-supplying coil 21 to the secondary power-supplying coil 22 is the same as the movement mechanism according to the first embodiment, a description thereof will be omitted.

Since the configuration of the movement structure 10 is the same as the movement mechanism according to the first embodiment except for supporting the plurality of secondary power-supplying coils 22, only different points therefrom will be described.

The movement structure 10 supports the plurality of secondary power-supplying coils 22 so that the plurality of secondary power-supplying coils 22 are arranged along the imaginary line X parallel to the movement path F.

The movement structure 10 may support the plurality of secondary power-supplying coils 22 so that the plurality of secondary power-supplying coils 22 are arranged in series along the imaginary line parallel to the movement path when the movement structure 10 moves along the movement path F.

The movement structure 10 may support the plurality of secondary power-supplying coils 22 so that the plurality of secondary power-supplying coils 22 are arranged in series along the imaginary line X parallel to the movement path F when guided by the movement guide mechanism 30.

Since configurations of the movement guide mechanism 30 and the power-supplying device 40 are the same as the movement mechanism according to the first embodiment, a description thereof will be omitted.

When the movement structure 10 moves along the movement path F, power can be supplied to one or more of the secondary power-supplying coils 22 sequentially selected from among the plurality of secondary power-supplying coils 22 depending on an arrangement sequence from one or more of the primary power-supplying coils 21 sequentially selected from among the plurality of primary power-supplying coils 21 depending on an arrangement sequence in a wireless manner so that the state, in which power is supplied in a wireless manner from the primary power-supplying coil 21 to the secondary power-supplying coil 22, is maintained.

When the movement structure 10 is guided by the movement guide mechanism 30 to move along the movement path F, power may be supplied to one or more of the secondary power-supplying coils 22 sequentially selected from among the plurality of secondary power-supplying coils 22 depending on an arrangement sequence from one or more of the primary power-supplying coils 21 sequentially selected from among the plurality of primary power-supplying coils 21 depending on an arrangement sequence in a wireless manner so that the state, in which power is supplied in a wireless manner from the primary power-supplying coil 21 to the secondary power-supplying coil 22, is maintained.

When the movement structure 10 is guided by the movement guide mechanism 30 to move along the movement path F, power can be supplied to one or more of the secondary power-supplying coils 22 sequentially selected from among the plurality of secondary power-supplying coils 22 depending on an arrangement sequence from one or more of the primary power-supplying coils 21 sequentially selected from among the plurality of primary power-supplying coils 21 to correspond to movement depending on an arrangement sequence in a wireless manner so that the state, in which power is supplied in a wireless manner from the primary power-supplying coil 21 to the secondary power-supplying coil 22, is maintained.

When the movement structure 10 is guided by the movement guide mechanism 30 to move along the movement path F, power can be supplied to one or more of the secondary power-supplying coils 22 sequentially selected from among the plurality of secondary power-supplying coils 22 to correspond to movement depending on an arrangement sequence from one or more of the primary power-supplying coils 21 sequentially selected from among the plurality of primary power-supplying coils 21 to correspond to movement depending on an arrangement sequence in a wireless manner so that the state, in which power is supplied in a wireless manner from the primary power-supplying coil 21 to the secondary power-supplying coil 22, is maintained.

When the movement structure 10 moves along the movement path F, the control device may sequentially select one or more of the primary power-supplying coils 21 from among the plurality of primary power-supplying coils 21 depending on an arrangement sequence so that the state, in which power is supplied in a wireless manner from the primary power-supplying coil 21 to the secondary power-supplying coil 22, is maintained, further sequentially select one or more of the secondary power-supplying coils 22 from among the plurality of secondary power-supplying coils 22 depending on an arrangement sequence, and supply power to the selected one or more secondary power-supplying coils 22 from the selected one or more primary power-supplying coils 21.

When the movement structure 10 is stopped at an arbitrary position of the movement path F, power may be supplied to one or more of the secondary power-supplying coils 22 selected from the plurality of secondary power-supplying coils 22 from one or more of the primary power-supplying coils 21 of the plurality of primary power-supplying coils 21 in a wireless manner so that the state, in which power is supplied in a wireless manner from the primary power-supplying coil 21 to the secondary power-supplying coil 22, is maintained.

When the movement structure 10 is guided by the movement guide mechanism 30 to stop at an arbitrary position of the movement path F, power may be supplied to one or more of the secondary power-supplying coils 22 selected from the plurality of secondary power-supplying coils 22 from one or more of the primary power-supplying coils 21 of the plurality of primary power-supplying coils 21 in a wireless manner so that the state, in which power is supplied in a wireless manner from the primary power-supplying coil 21 to the secondary power-supplying coil 22, is maintained.

When the movement structure 10 is stopped at an arbitrary position of the movement path F, the control instrument 41 may select one or more of the primary power-supplying coils 21 of the plurality of primary power-supplying coils 21 so that the state, in which power is supplied in a wireless manner from the primary power-supplying coil 21 to the secondary power-supplying coil 22, is maintained, further select one or more of the secondary power-supplying coils 22 selected from the plurality of secondary power-supplying coils 22, and supply power to the selected one or more secondary power-supplying coils 22 from the selected one or more primary power-supplying coils 21.

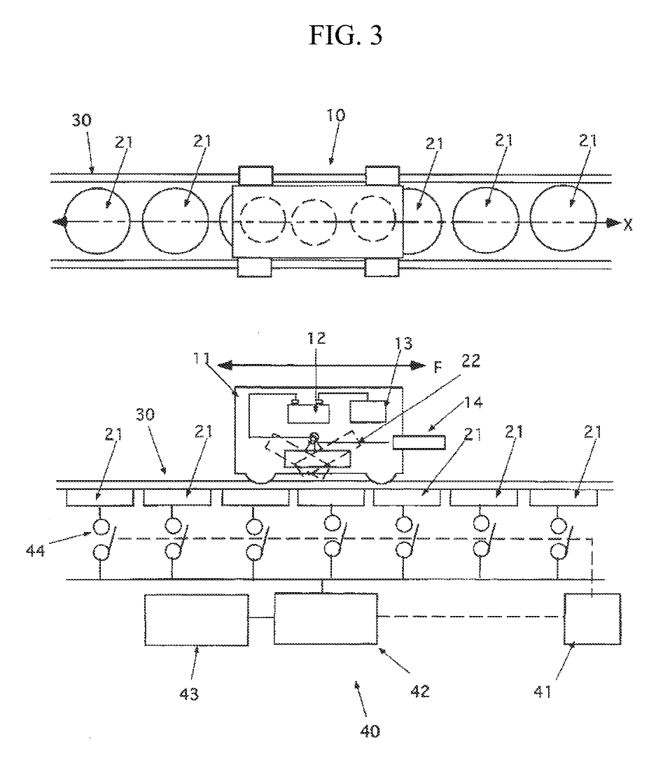

Next, a movement mechanism according to a third embodiment of the present disclosure will be described with reference to FIG. 3.

FIG. 3 is a conceptual view of the movement mechanism according to the third embodiment of the present disclosure.

The movement mechanism is a mechanism that can move along the movement path F.

The movement mechanism is constituted by a plurality of primary power-supplying coils 21, a secondary power-supplying coil 22 and a movement structure 10.

The movement mechanism may be constituted by the plurality of primary power-supplying coils 21, the secondary power-supplying coil 22, the movement structure 10 and a movement guide mechanism 30, or may be constituted by the plurality of primary power-supplying coils 21, the secondary power-supplying coil 22, the movement structure 10, the movement guide mechanism 30 and a power-supplying device 40.

Since the structure of the plurality of primary power-supplying coils is the same as the movement mechanism according to the first embodiment, a description thereof will be omitted.

The secondary power-supplying coil 22 serving as a power-supplying coil that receives power from another power-supplying coil in a wireless manner is supported by the movement structure 10 so that the posture thereof can be varied.

The secondary power-supplying coil 22 serving as a power-supplying coil that receives power from the primary power-supplying coil 21 in a wireless manner is supplied by the movement structure 10 so that the posture thereof is varied.

Since an aspect of supplying power from the primary power-supplying coil 21 to the secondary power-supplying coil 22 in a wireless manner is the same as the movement mechanism according to the first embodiment, a description thereof will be omitted.

Since the configuration of the movement structure 10 is the same as the movement mechanism according to the first embodiment except for the structure that supports the secondary power-supplying coil 22, only different points therefrom will be described.

The movement structure 10 is a structure that supports the secondary power-supplying coil 22 and moves along the movement path F.

The movement structure 10 is constituted by the movement structure main body 11, the storage cell 12, the electric load 13 and a coil positioning mechanism 14.

Since the structure of the movement structure main body 11, the storage cell 12 and the electric load 13 is the same as the movement mechanism according to the first embodiment, a description thereof will be omitted.

The coil positioning mechanism 14 is a mechanism that is supported by the movement structure main body and varies the posture of the secondary power-supplying coil.

The coil positioning mechanism 14 may swing the secondary power-supplying coil 22.

For example, the coil positioning mechanism 14 swings the secondary power-supplying coil 22 about a horizontal axis perpendicular to the imaginary line.

Since the configurations of the movement guide mechanism 30 and the power-supplying device 40 are the same as the movement mechanism according to the first embodiment, a description thereof will be omitted.

When the movement structure 10 is stopped at an arbitrary position of the movement path F, the coil positioning mechanism 14 varies the posture of the secondary power-supplying coil 22 so that the state, in which power is supplied in a wireless manner to the secondary power-supplying coil 22 from one or more of the primary power-supplying coils 21 among the plurality of primary power-supplying coils 21, can be maintained.

When the movement structure 10 is guided by the movement guide mechanism 30 to stop at an arbitrary position of the movement path F, the coil positioning mechanism 14 may vary the posture of the secondary power-supplying coil 22 so that the state, in which power is supplied in a wireless manner to the secondary power-supplying coil 22 from one or more of the primary power-supplying coils 21 among the plurality of primary power-supplying coils 21, can be maintained.

When the movement structure 10 is stopped at an arbitrary position of the movement path F, the coil positioning mechanism 14 varies the posture of the secondary power-supplying coil 22 to a posture having relatively better efficiency of supplying power to the secondary power-supplying coil 22 from the primary power-supplying coil 21 in a wireless manner so that the state, in which power is supplied in a wireless manner to the secondary power-supplying coil 22 from one or more of the primary power-supplying coils 21 among the plurality of primary power-supplying coils 21, can be maintained.

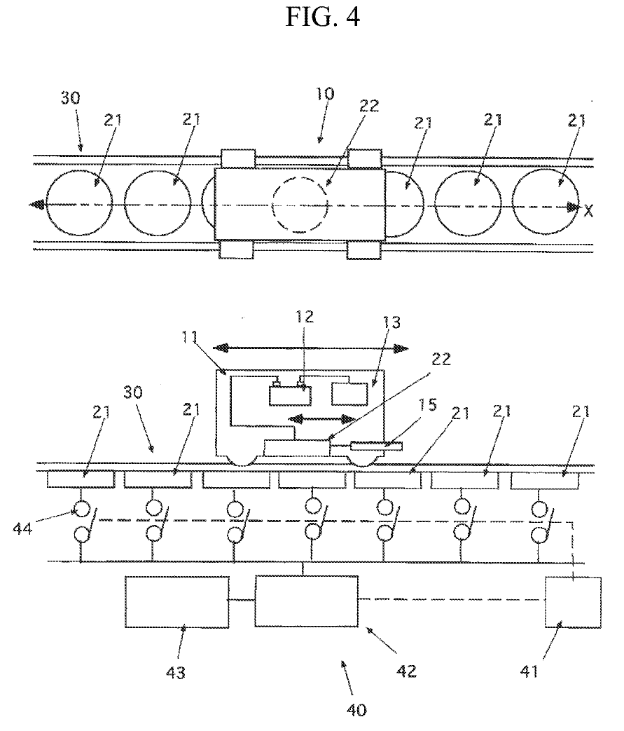

Next, a movement mechanism according to a fourth embodiment according to the present disclosure will be described with reference to FIG. 4.

FIG. 4 is a conceptual view of the movement mechanism according to the fourth embodiment of the present disclosure.

The movement mechanism is a mechanism that can move along the movement path F.

The movement mechanism is constituted by a plurality of primary power-supplying coils 21, a secondary power-supplying coil 22 and a movement structure 10.

The movement mechanism may be constituted by the plurality of primary power-supplying coils 21, the secondary power-supplying coil 22, the movement structure 10 and a movement guide mechanism 30, or may be constituted by the plurality of primary power-supplying coils 21, the secondary power-supplying coil 22, the movement structure 10, the movement guide mechanism 30 and a power-supplying device 40.

Since the configuration of the plurality of primary power-supplying coils is the same as the movement mechanism according to the first embodiment, a description thereof will be omitted.

The secondary power-supplying coil 22 is a power-supplying coil configured to receive power from another power-supplying coil in a wireless manner, and is supported by the movement structure 10 so that the secondary power-supplying coil 22 can be moved along the imaginary line parallel to the movement path.

The secondary power-supplying coil 22 is a power-supplying coil configured to receive power from the primary power-supplying coil 21 in a wireless manner, and is supported by the movement structure 10 so that the secondary power-supplying coil 22 can be moved along the imaginary line parallel to the movement path.

Since the aspect of supplying power from the primary power-supplying coil 21 to the secondary power-supplying coil 22 in a wireless manner is the same as the movement mechanism according to the first embodiment, a description thereof will be omitted.

Since the configuration of the movement structure 10 is the same as the movement mechanism according to the first embodiment except for the structure configured to support the secondary power-supplying coil 22, only different points therefrom will be described.

The movement structure 10 is a structure configured to support the secondary power-supplying coil 22 and move along the movement path F.

The movement structure 10 is constituted by the movement structure main body 11, the storage cell 12, the electric load 13 and a coil movement mechanism 15.

The movement structure 10 may be constituted by the movement structure main body 11, the storage cell 12, the electric load 13, a coil guide mechanism (not shown) and the coil movement mechanism 15.

Since the structure of the movement structure main body 11, the storage cell 12 and the electric load 13 is the same as the movement mechanism according to the first embodiment, a description thereof will be omitted.

The coil guide mechanism (not shown) is a mechanism supported by the movement structure main body and configured to movably guide the secondary power-supplying coil along the imaginary line parallel to the movement path.

The coil guide mechanism (not shown) is a mechanism supported by the movement structure main body when the movement structure 10 moves along the movement path F and configured to movably guide the secondary power-supplying coil along the imaginary line parallel to the movement path.

For example, the coil guide mechanism is a linear guide.

The coil movement mechanism 15 is a mechanism configured to move the secondary power-supplying coil along the imaginary line.

The coil movement mechanism 15 is a mechanism configured to move the secondary power-supplying coil along the imaginary line when the movement structure 10 moves along the movement path F.

For example, the coil positioning mechanism 14 is a direct motion actuator.

Since the configuration of the movement guide mechanism 30 and the power-supplying device 40 is the same as the movement mechanism according to the first embodiment, a description thereof will be omitted.

When the movement structure 10 is stopped at an arbitrary position of the movement path F, the coil movement mechanism 15 moves the secondary power-supplying coil 22 along the imaginary line so that the state, in which power is supplied in a wireless manner to the secondary power-supplying coil 22 from one or more of the primary power-supplying coils 21 among the plurality of primary power-supplying coils 21, can be maintained.

When the movement structure 10 is guided by the movement guide mechanism 30 to stop at an arbitrary position of the movement path F, the coil movement mechanism 15 moves the secondary power-supplying coil 22 along the imaginary line so that the state, in which power is supplied in a wireless manner to the secondary power-supplying coil 22 from one or more of the primary power-supplying coils 21 among the plurality of primary power-supplying coils 21, can be maintained.

When the movement structure 10 is stopped at an arbitrary position of the movement path F, the coil movement mechanism 15 moves a position of the secondary power-supplying coil 22 to a position at which efficiency of supplying power from the primary power-supplying coil 21 to the secondary power-supplying coil 22 in a wireless manner is relatively better so that the state, in which power is supplied in a wireless manner to the secondary power-supplying coil 22 from one or more of the primary power-supplying coils 21 among the plurality of primary power-supplying coils 21, can be maintained.

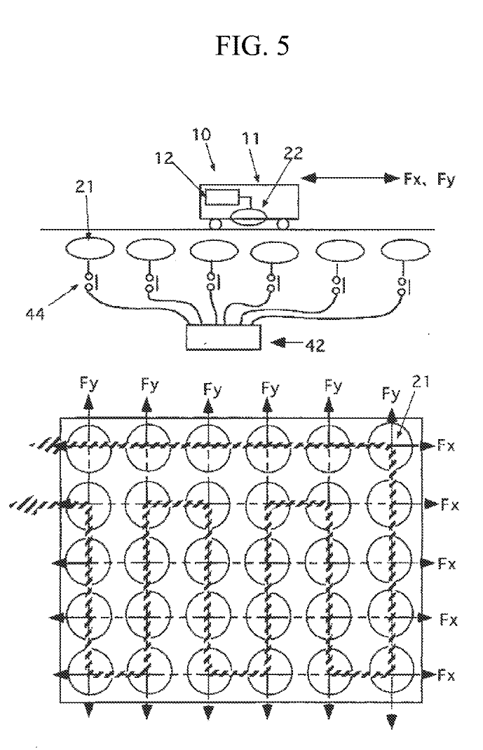

Next, a movement mechanism according to a fifth embodiment of the present disclosure will be described with reference to FIG. 5.

FIG. 5 is a conceptual view of the movement mechanism according to the fifth embodiment of the present disclosure.

The movement mechanism according to the fifth embodiment of the present disclosure is a mechanism in which the present disclosure is applied to an automatic guided vehicle (AGV).

The movement mechanism is a mechanism that can move along the movement path F.

The movement path F is constituted by an X-axis movement path Fx and a Y-axis movement path Fy, which are movement paths crossing each other.

The movement path F may be a path formed by selecting the X-axis movement path Fx and the Y-axis movement path Fy and drawn with a single stroke.

FIG. 5 shows an example of a movement path drawn with a single stroke.

The movement path F is constituted by a plurality of X-axis movement paths and a plurality of Y-axis movement paths, which are movement paths crossing each other.

The movement path F is constituted by a plurality of X-axis movement paths and a plurality of Y-axis movement paths, which are movement paths crossing each other in a grid pattern.

The movement mechanism is constituted by a plurality of primary power-supplying coils 21, a secondary power-supplying coil 22 and a movement structure 10.

The movement mechanism may be constituted by the plurality of primary power-supplying coils 21, the secondary power-supplying coil 22, the movement structure 10 and a movement guide mechanism 30.

The movement mechanism is constituted by the plurality of primary power-supplying coils 21, the secondary power-supplying coil 22, the movement structure 10, the movement guide mechanism 30 and a power-supplying device 40.

Since the configuration of the plurality of primary power-supplying coils 21, the secondary power-supplying coil 22 and the movement structure 10 is the same as described above except that the movement structure 10 is the AGV and the movement guide mechanism is a guide system of the AGV, a description thereof will be omitted.

For example, the guide system is a magnetic induction system, an optical induction system, an electromagnetic induction system, or the like, which is installed on a floor.

The magnetic induction system, the optical induction system and the electromagnetic induction system are installed along the movement path.

The movement structure 10 moves along either movement path selected from the X-axis movement path Fx or the Y-axis movement path Fy.

The movement structure is guided by the movement guide mechanism to movably guide the movement structure along either movement path sequentially selected from the X-axis movement path or the Y-axis movement path.

For example, the AGV moves along either movement path selected from the X-axis movement path or the Y-axis movement path.

For example, the AGV is guided by the guide system to move along either movement path selected from the X-axis movement path or the Y-axis movement path.

For example, the AGV is induced and moved by the induction system installed at either movement path selected from the induction system installed at the X-axis movement path or the induction system installed at the Y-axis movement path.

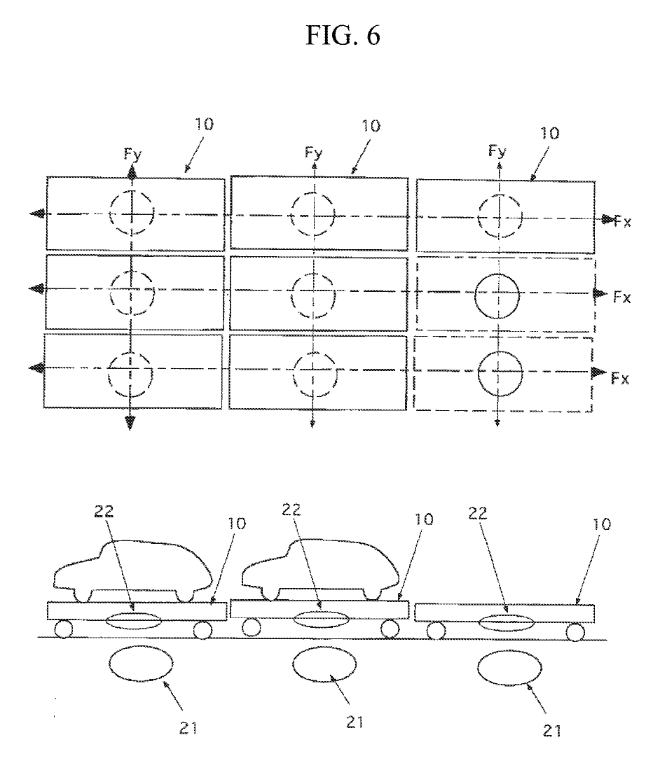

Next, a movement mechanism according to a sixth embodiment of the present disclosure will be described based on FIG. 6.

FIG. 6 is a conceptual view of the movement mechanism according to the sixth embodiment.

The movement mechanism according to the sixth embodiment of the present disclosure is a mechanism in which the present disclosure is applied to a mechanical parking apparatus.

The movement mechanism is a mechanism that can move along the movement path F.

The movement path F is constituted by an X-axis movement path and a Y-axis movement path that are movement paths crossing each other.

The movement path F may be constituted by a plurality of X-axis movement paths and a plurality of Y-axis movement paths, which are movement paths crossing each other, or may be constituted by a plurality of X-axis movement paths and a plurality of Y-axis movement paths, which are movement paths crossing each other in a grid pattern.

The movement mechanism is constituted by a plurality of primary power-supplying coils 21, a secondary power-supplying coil 22 and a movement structure 10.

The movement mechanism may be constituted by the plurality of primary power-supplying coils 21, the secondary power-supplying coil 22, the movement structure 10 and a movement guide mechanism 30, or may be constituted by the plurality of primary power-supplying coils 21, the secondary power-supplying coil 22, the movement structure 10, the movement guide mechanism 30 and a power-supplying device 40.

Since the configuration of the plurality of primary power-supplying coils 21, the secondary power-supplying coil 22 and the movement structure 10 is the same as described above except that the movement structure 10 is a pallet and the movement guide mechanism is a guide system of the pallet, a description thereof will be omitted.

The pallet is a structure that supports a vehicle.

For example, the guide system is a guide member, a traveling rail, or the like, installed at a floor.

The guide member, a traveling rail, or the like, is installed along the movement path.

The movement structure 10 moves along either movement path selected from the X-axis movement path Fx or the Y-axis movement path Fy.

The movement structure 10 may move along either movement path sequentially selected from the X-axis movement path Fx or the Y-axis movement path Fy, or may be guided by the movement guide mechanism so that the movement guide 10 is movably guided along either movement path selected from the X-axis movement path or the Y-axis movement path.

For example, the pallet moves along either movement path selected from the X-axis movement path or the Y-axis movement path.

For example, the pallet is guided by the guide system to move along either movement path selected from the X-axis movement path or the Y-axis movement path.

For example, the pallet is induced and moved by a guide mechanism or a traveling rail installed at any one movement path selected from the guide mechanism or the traveling rail installed at the X-axis movement path and the guide mechanism or the traveling rail installed at the Y-axis movement path.

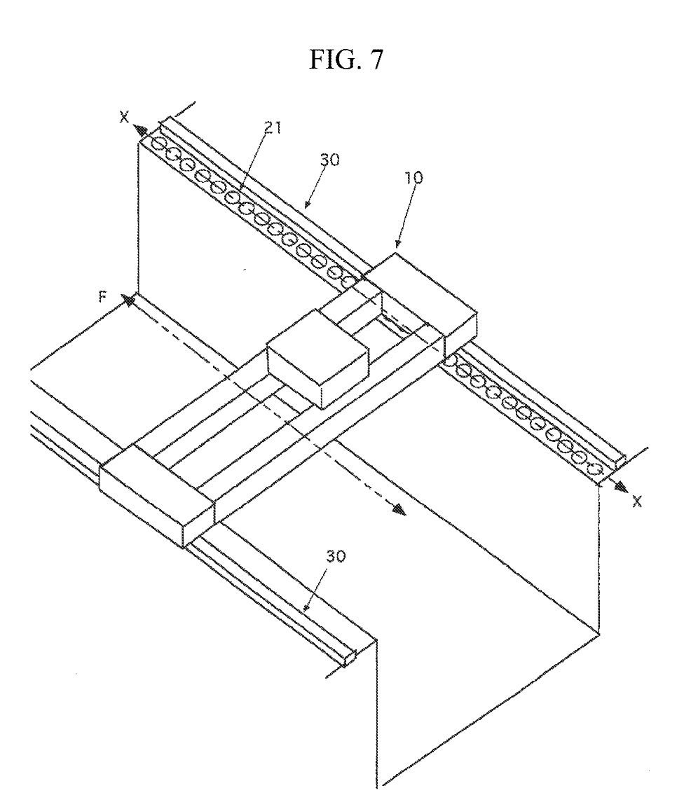

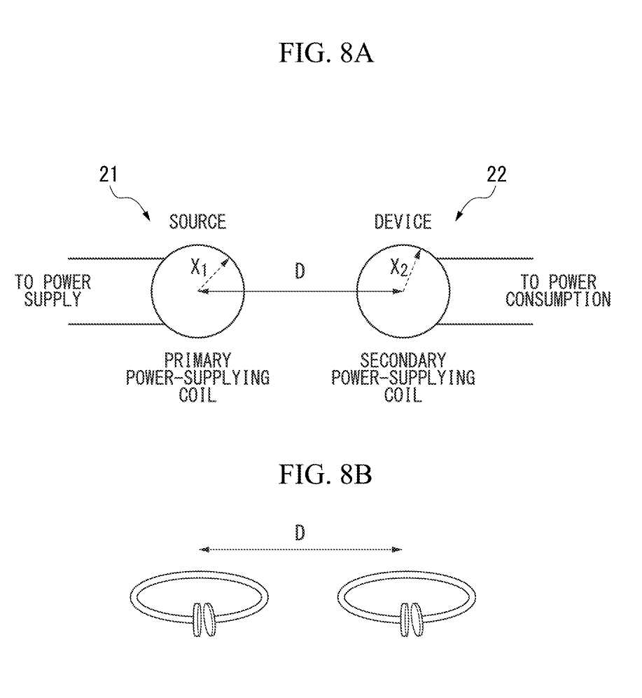

Next, a movement mechanism according to a seventh embodiment of the present disclosure will be described based on FIG. 7.

FIG. 7 is a conceptual view of the movement mechanism according to the seventh embodiment of the present disclosure.

The movement mechanism according to the seventh embodiment of the present disclosure is a mechanism in which the present disclosure is applied to a crane.

The movement mechanism is a mechanism that can move along the movement path F.

The movement mechanism is constituted by a plurality of primary power-supplying coils 21, a secondary power-supplying coil 22 and a movement structure 10.

The movement mechanism may be constituted by the plurality of primary power-supplying coils 21, the secondary power-supplying coil 22, the movement structure 10 and a movement guide mechanism 30, or may be constituted by the plurality of primary power-supplying coils 21, the secondary power-supplying coil 22, the movement structure 10, the movement guide mechanism 30 and a power-supplying device 40.

Since the configuration of the plurality of primary power-supplying coils 21, the secondary power-supplying coil 22 and the movement structure 10 is the same as described above except that the movement structure 10 is a crane and the movement guide mechanism is a guide system of the crane, a description thereof will be omitted.

For example, the guide system is a traveling rail or the like installed at a floor.

The traveling rail or the like is installed along the movement path.

The movement structure 10 moves along the movement path F.

For example, the crane moves along the movement path F.

For example, the crane is guided by the traveling rail to move along the movement path F.

The movement mechanism according to the embodiment of the present disclosure has the following effects due to its configuration.

When the movement structure 10 is guided by the movement guide mechanism 30 to move along the movement path F, since power can be supplied to the secondary power-supplying coil 22 supported by the movement structure 10 from one or more of the primary power-supplying coils 21 sequentially selected from among the plurality of primary power-supplying coils 21 arranged along the imaginary line X parallel to the movement path F to correspond to movement depending on an arrangement sequence in a wireless manner, the power can be supplied to the movement structure 10 that is moving.

In addition, when the movement structure 10 is guided by the movement guide mechanism 30 to move along the movement path, since the state, in which power is supplied in a wireless manner to the secondary power-supplying coil 22 supported by the movement structure 10 from one or more of the primary power-supplying coils 21 sequentially selected from among the plurality of primary power-supplying coils 21 arranged along the imaginary line X parallel to the movement path F to correspond to movement depending on an arrangement sequence, can be maintained, the power can be continuously supplied to the movement structure 10 that is moving.

In addition, when the movement structure 10 is guided by the movement guide mechanism 30 to stop at an arbitrary position of the movement path, since the state, in which power is supplied in a wireless manner to the secondary power-supplying coil 22 supported by the movement structure 10 from one or more of the primary power-supplying coils 21 among the plurality of primary power-supplying coils 21 arranged along the imaginary line X parallel to the movement path F, can be maintained, the power can be continuously supplied to the movement structure 10 that is stopped.

In addition, when the movement structure 10 is guided by the movement guide mechanism 30 to move along the movement path F, since the state, in which power is supplied in a wireless manner to one or more of the secondary power-supplying coils 22 sequentially selected from among the plurality of secondary power-supplying coils 22 supported by the movement structure 10 to correspond to movement depending on an arrangement sequence from one or more of the primary power-supplying coils 21 sequentially selected from among the plurality of primary power-supplying coils 21 arranged along the imaginary line X parallel to the movement path F to correspond to movement depending on an arrangement sequence, can be maintained, the power can be continuously supplied to the movement structure 10 that is moving.

In addition, when the movement structure 10 is guided by the movement guide mechanism 30 to stop at an arbitrary position of the movement path F, since the state, in which power is supplied in a wireless manner to one or more of the secondary power-supplying coils 22 sequentially selected from among the plurality of secondary power-supplying coils 22 supported by the movement structure 10 depending on an arrangement sequence from one or more of the primary power-supplying coils 21 sequentially selected from among the plurality of primary power-supplying coils 21 arranged along the imaginary line X parallel to the movement path F depending on an arrangement sequence, can be maintained, the power can be continuously supplied to the movement structure 10 that is moving.

In addition, when the movement structure 10 is guided by the movement guide mechanism 30 to stop at an arbitrary position of the movement path F, since the coil positioning mechanism 14 varies the posture of the secondary power-supplying coil 22 and the state, in which power is supplied in a wireless manner to the secondary power-supplying coil 22 from one or more of the primary power-supplying coils 21 among the plurality of primary power-supplying coils 21, can be maintained, the power can be continuously supplied to the movement structure 10 that is stopped.

In addition, when the movement structure 10 is guided by the movement guide mechanism 30 to stop at an arbitrary position of the movement path F, since the coil movement mechanism 15 moves the secondary power-supplying coil 22 along the imaginary line X so that the state, in which power is supplied in a wireless manner to the secondary power-supplying coil 22 from one or more of the primary power-supplying coils 21 among the plurality of primary power-supplying coils 21, can be maintained, the power can be continuously supplied to the movement structure 10 that is stopped.

In addition, since the movement structure 10 is guided by the movement guide mechanism 30 to move along either movement path F selected from the X-axis movement path Fx or the Y-axis movement path Fy, which cross each other, the power can be supplied to the movement structure 10 moving along the X-axis movement path Fx and the Y-axis movement path Fy, which cross each other.

The present disclosure is not limited to the above-mentioned embodiments but various modifications may be made without departing from the spirit of the present disclosure.

The present disclosure provides the movement mechanism that can supply power to the movement structure that is moving.

1. A movement mechanism that is able to move along a movement path, the movement mechanism comprising:
a plurality of primary power-supplying coils each serving as a power-supplying coil that is able to supply power to another power-supplying coil in a wireless manner and arranged along an imaginary line parallel to the movement path;
a secondary power-supplying coil serving as a power-supplying coil configured to receive power from another power-supplying coil in a wireless manner; and
a movement structure serving as a structure configured to support the secondary power-supplying coil and to move along the movement path,
wherein power is able to be supplied in a wireless manner to the secondary power-supplying coil from one or more of the primary power-supplying coils sequentially selected from among the plurality of primary power-supplying coils depending on an arrangement sequence when the movement structure moves along the movement path.

2. The movement mechanism according to claim 1, wherein a state, in which power is supplied in a wireless manner to the secondary power-supplying coil from one or more of the primary power-supplying coils sequentially selected from among the plurality of primary power-supplying coils depending on an arrangement sequence, is able to be maintained when the movement structure moves along the movement path.

3. The movement mechanism according to claim 1, wherein a state, in which power is supplied in a wireless manner to the secondary power-supplying coil from one or more of the primary power-supplying coils among the plurality of primary power-supplying coils, is able to be maintained when the movement structure is stopped at an arbitrary position of the movement path.

4. The movement mechanism according to claim 2, wherein a state, in which power is supplied in a wireless manner to the secondary power-supplying coil from one or more of the primary power-supplying coils among the plurality of primary power-supplying coils, is able to be maintained when the movement structure is stopped at an arbitrary position of the movement path.

5. The movement mechanism according to claim 1, comprising the plurality of secondary power-supplying coils,
wherein the movement structure supports the plurality of secondary power-supplying coils so that the plurality of secondary power-supplying coils are arranged along the imaginary line parallel to the movement path, and
power is able to be supplied in a wireless manner to one or more of the secondary power-supplying coils sequentially selected from among the plurality of secondary power-supplying coils depending on an arrangement sequence from one or more of the primary power-supplying coils sequentially selected from among the plurality of primary power-supplying coils depending on an arrangement sequence so that a state, in which power is supplied in a wireless manner from the primary power-supplying coil to the secondary power-supplying coil, is maintained when the movement structure moves along the movement path.

6. The movement mechanism according to claim 1, comprising the plurality of secondary power-supplying coils,
wherein the movement structure supports the plurality of secondary power-supplying coils so that the plurality of secondary power-supplying coils are arranged along the imaginary line parallel to the movement path, and
power is able to be supplied in a wireless manner to one or more of the secondary power-supplying coils selected from the plurality of secondary power-supplying coils from one or more of the primary power-supplying coils among the plurality of primary power-supplying coils so that a state, in which power is supplied in a wireless manner from the primary power-supplying coil to the secondary power-supplying coil, is maintained when the movement structure is stopped at an arbitrary position of the movement path.

7. The movement mechanism according to claim 1, wherein the movement structure has a movement structure main body and a coil positioning mechanism supported by the movement structure main body and configured to vary a posture of the secondary power-supplying coil, and
the coil positioning mechanism varies the posture of the secondary power-supplying coil so that a state, in which power is supplied in a wireless manner to the secondary power-supplying coil from one or more of the primary power-supplying coils among the plurality of primary power-supplying coils, is able to be maintained when the movement structure is stopped at an arbitrary position of the movement path.

8. The movement mechanism according to claim 1, wherein the movement structure has a movement structure main body and a coil movement mechanism configured to move the secondary power-supplying coil along the imaginary line, and
the coil movement mechanism moves the secondary power-supplying coil along the imaginary line so that a state, in which power is supplied in a wireless manner to the secondary power-supplying coil from one or more of the primary power-supplying coils among the plurality of primary power-supplying coils, is able to be maintained when the movement structure is stopped at an arbitrary position of the movement path.

9. The movement mechanism according to claim 1, wherein the movement path has an X-axis movement path and a Y-axis movement path that are movement paths crossing each other, and the movement structure moves along either movement path selected from the X-axis movement path or the Y-axis movement path.
